(19) United States
(12) Patent Application Publication
(10) Pub. No.: US 2018/0314111 A1
(43) Pub. Date: Nov. 1, 2018

(54) DISPLAY SUBSTRATE, DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Jian GAO, Beijing (CN); Xue DONG, Beijing (CN); Xiaochuan CHEN, Beijing (CN); Wenqing ZHAO, Beijing (CN); Qian WANG, Beijing (CN); Ming YANG, Beijing (CN); Pengcheng LU, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/532,263

(22) PCT Filed: Sep. 2, 2016
(86) PCT No.: PCT/CN2016/097844

§ 371 Date: Jun. 1, 2017

(30) Foreign Application Priority Data
Jan. 8, 2016 (CN) 201610011930.6

(51) Int. Cl. G02F 1/1335; G02F 1/1339; G06F 3/01

(52) U.S. Cl. CPC G02F 1/133606; G02F 1/133603; G02F 2203/30; G02F 1/1339; G06F 3/013; G02F 1/133528

(57) ABSTRACT

A display substrate, a display panel and a display device are provided. The display substrate includes a base, a first polarizer at one side of the base, and a light-splitting film between the first polarizer and the base. Multiple light-splitting structures are formed on a surface of the light-splitting film facing one side of the base, and the surface is divided into multiple light-splitting units, and the light-splitting structures in each light-splitting unit split light incident onto the light-splitting unit into multiple beams of light having different wavelengths and emergent directions. The display panel includes a first display substrate and a second display substrate arranged opposite to and forming a cell with the first display substrate, the first display substrate is the above display substrate. The display device includes the above display panel and a backlight source, a polarizer of the first display substrate faces the backlight source.

### CROSS-REFERENCE TO RELATED APPLICATIONS

The present application claims a priority of a Chinese patent application No. 201610011930.6 filed in China on Jan. 8, 2016, contents of which are incorporated herein by reference in its entirety.

### TECHNICAL FIELD

The present disclosure relates to a field of display, and in particular, relates to a display substrate, a display panel including the display substrate and a display device including the display panel.

### BACKGROUND

In a related art, a common liquid crystal display device includes a backlight source, an array substrate, a cell-alignment substrate, and a liquid crystal layer encapsulated between the array substrate and the cell-alignment substrate. A color filter film is provided on the cell-alignment substrate and includes color-resist blocks of three colors, such as red color-resist blocks (R), green color-resist blocks (G) and blue color-resist blocks (B).

A disadvantage of such a liquid crystal display device is relatively high energy consumption. Hence, how to reduce the energy consumption of such a liquid crystal display device becomes an urgent problem to be solved in the field.

### SUMMARY

An object of the present disclosure is to provide a display substrate, a display panel and a display device. The display device has lower energy consumption.

To achieve the above object, a display substrate is provided in a first aspect of the present disclosure. The display substrate includes a base, a first polarizer arranged at one side of the base, and a light-splitting film arranged between the first polarizer and the base. A plurality of light-splitting structures are formed on a surface of the light-splitting film facing one side of the base, and the surface of the light-splitting film facing one side of the base is divided into a plurality of light-splitting units, and light-splitting structures in each light-splitting unit may split light incident onto the light-splitting unit into multiple beams of light having different wavelengths and different emergent directions.

Optionally, a plurality of pixel units are arranged at the other side of the base and each of the plurality of light-splitting units corresponds to one of the pixel units.

Optionally, each of the plurality of pixel units includes three subpixel units, and the light-splitting structures in each of the plurality of light-splitting units may split incident light into a red light ray, a green light ray and a blue light ray which enter corresponding ones of the three subpixel units, respectively.

Optionally, a pixel circuit is formed at the other side of the base.

Optionally, the display substrate further includes an adhesive for attaching the light-splitting film with the base, wherein the adhesive is arranged to surround edges of the base.

Optionally, each of the plurality of light-splitting units includes three light-splitting structures, and a light-splitting surface of each of the three light-splitting structures has a stepped shape.

A display panel is provided in a second aspect of the present disclosure. The display panel includes a first display substrate, and a second display substrate arranged opposite to and forming a cell with the first display substrate, wherein the first display substrate is the display substrate provided by the first aspect of the present disclosure.

Optionally, a second polarizer is formed at a side of the second display substrate facing away from the first display substrate, and a polarization direction of the second polarizer is perpendicular to a polarization direction of the first polarizer.

A display device is provided in a third aspect of the present disclosure. The display device includes a display panel provided by the second aspect of the present disclosure and a backlight source, wherein the polarizer of the first display substrate of the display panel faces the backlight source.

Optionally, the backlight source is divided into a plurality of light-emitting regions, each of which has at least one light-emitting diode provided therein.

Optionally, the backlight source and the display panel are adhered together by a sealant surrounding the display panel.

Optionally, the backlight source, the display panel and the sealant form a closed chamber together.

Optionally, the display device further includes a backlight-source control module. Light emitting regions of the backlight source include light emitting subregions and shielding subregions which are arranged alternately, and the backlight-source control module may control light-emitting diodes of the shielding subregions to not emit light and control light-emitting diodes of light-emitting subregion to emit light.

Optionally, the display substrate further includes an eye tracking module and a grayscale control module, wherein the eye tracking module may obtain location information of eyes of an observer and send the obtained location information of the eyes to the grayscale control module, and the grayscale control module may generate an image directly facing the eyes of the observer according to the location information of the eyes received by the grayscale control module.

In the display substrate provided by the present disclosure, light passing through the light-splitting film and incident onto the base is colored light that does not need to be filtered by a color filter film, and a brightness of the display panel including the display substrate provided by the present disclosure may be increased. When the same energy is consumed, the brightness of the display device including the display substrate provided by the present disclosure is about three times of that of the display device including a color filter film. In other words, a display image having a desired brightness can be generated with lower energy consumption. Hence, the display substrate provided by the present disclosure, when being applied to a display device, may make the display device more energy-efficient.

### BRIEF DESCRIPTION OF THE DRAWINGS

The accompanying drawings are used to enhance understanding of the present disclosure, constitute a part of the description, and are used to explain the present disclosure together with specific embodiments hereinafter, but not to limit the scope of the present disclosure. In the accompanying drawings,

FIG. 1 is a structural schematic diagram of a liquid crystal display device in the related art;

FIG. 2 is a structural schematic diagram of a display substrate provided in the present disclosure;

FIG. 3 is a principle diagram of a light-splitting unit of a display substrate provided in the present disclosure;

FIG. 4 is a structural schematic diagram of a display panel provided in the present disclosure;

FIG. 5 is a structural schematic diagram of a display device provided in the present disclosure;

FIG. 6a is a principle schematic diagram of the display device of FIG. 5 when a stereoscopic display mode is performed;

FIG. 6b is a principle schematic diagram of the display device of FIG. 5 when a planar display mode is performed;

FIG. 7a is a principle schematic diagram of the display device of FIG. 5 when eyes of an observer are located at one position;

FIG. 7b is a principle schematic diagram of the display device of FIG. 5 when the eyes of the observer are located at another position; and

FIG. 8 is a principle schematic diagram of a display device of the present disclosure.

### REFERENCE NUMERALS:

| | |
|---|---|
| 2: display panel; | 3: display device; |
| 100: backlight source; | 110: light-emitting diode; |
| 100a: light-emitting subregion; | 100b: shielding subregion; |
| 200: first display substrate; | 210: first polarizer; |
| 220: light-splitting film; | 230: adhesive; |
| 240: base; | 250: pixel circuit; |
| 251: red subpixel unit; | 252: green subpixel unit; |
| 253: blue subpixel unit; | 300: liquid crystal layer; |
| 400: second display substrate; | 500: sealant; |
| 410: second polarizer; | 2201: light-splitting structure; |
| 2202: light-splitting structure; | 2501r: red subpixel unit; |
| 2203: light-splitting structure; | 2501g: green subpixel unit; |
| 2501b: blue subpixel unit; | 801: backlight-source control module; |
| 802: eye tracking module; | 803: grayscale control module. |

### DETAILED DESCRIPTION

Specific embodiments of the present disclosure will be described in detail in conjunction with the accompanying drawings hereinafter. It should be understood that, the specific embodiments described herein are used for illustration and explanation only, but not for limiting the scope of the present disclosure.

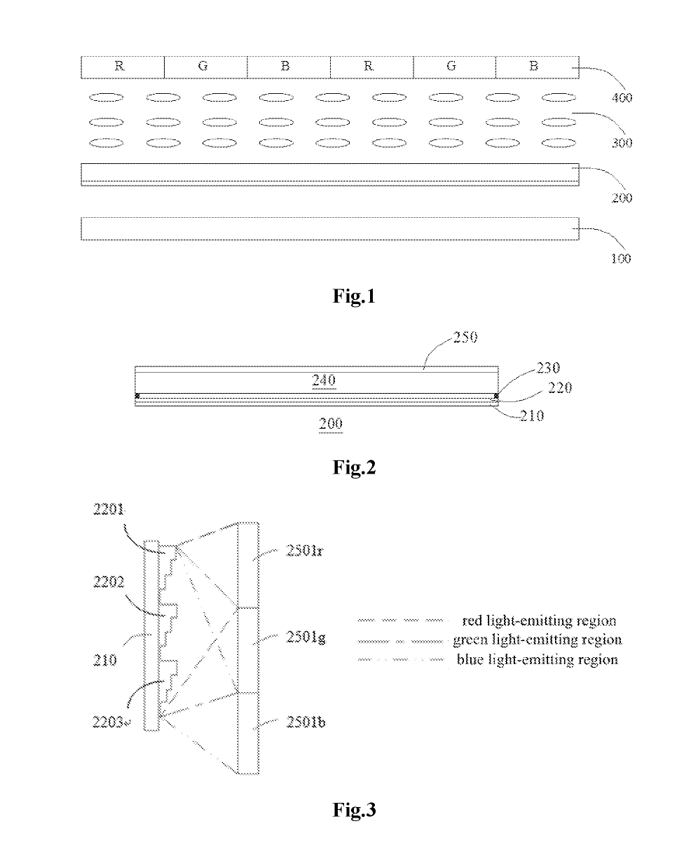

FIG. 1 illustrates a structural schematic structure of a common liquid crystal display device in the related art. The liquid crystal display device includes a backlight source 100, an array substrate 200, a cell-alignment substrate 400, and a liquid crystal layer 300 encapsulated between the array substrate 200 and the cell-alignment substrate 400. A color filter film is arranged on the cell-alignment substrate 400, and includes color-resist blocks of three colors, such as red color-resist blocks (R), green color-resist blocks (G) and blue color-resist blocks (B).

In operation, the backlight source 100 emits white light. When the white light passes through the red color-resist block (R), a light ray of the red color is transmitted and light rays of other colors are filtered out. When the white light passes through the green color-resist block (G), a light ray of the green color is transmitted and light rays of other colors are filtered out. When the white light passes through the blue color-resist block (B), a light ray of the blue color is transmitted and light rays of other colors are filtered out. That is to say, when the white light passes through each kind of color-resist blocks, two thirds of the white light is filtered out. Thus, such color filter film may reduce a brightness of the display. In order to obtain a desired brightness, the brightness of the backlight source needs to be increased, thus increasing energy consumption.

In view of this, the present disclosure provides a display substrate as shown in FIG. 2. The display substrate 200 includes a base 240, a first polarizer 210 arranged at one side of the base 240, and a light-splitting film 220 arranged between the first polarizer 210 and the base 240. A plurality of light-splitting structures (the light-splitting structures will be described in detail with reference to FIG. 3) are formed on a surface of the light-splitting film 220 facing one side of the base 240, and the surface of the light-splitting film 220 facing one side of the base 240 is divided into a plurality of light-splitting units (specific structures of the light-splitting units are shown in FIG. 3). The light-splitting structures in each light-splitting unit may split light incident onto the light-splitting unit into multiple beams of light having different wavelengths and different emergent directions.

When the display substrate 200 provided by the present disclosure is used in a display panel, the display substrate 200 is located at a light-incident side of the display panel. When white light emitted from the backlight source is incident onto the first polarizer 210, white linearly polarized light, after passing through the light-splitting film 220, is split into multiple beams of linearly polarized light having different wavelengths (i.e., having different colors) and different emergent directions due to an arrangement of the light-splitting film 220 between the first polarizer 210 and the base 240.

When the white light emitted from the backlight source passes through the first polarizer 210, most of polarized light parallel with a polarization direction of the first polarizer 210 is absorbed, and most of polarized light perpendicular to the polarization direction of the first polarizer 210 is transmitted. Obtaining the linearly polarized light firstly and then splitting the linearly polarized light by using the light-splitting film 220 may improve light transmittance and reduce light loss.

The multiple beams of light emergent from each light-splitting unit have different colors, and each light-splitting unit may correspond to one pixel unit on the display panel. It is readily understood that each pixel unit may include a plurality of subpixel units, and the multiple beams of light split from the light-splitting unit are incident onto corresponding subpixel units of a corresponding pixel unit, respectively, so as to perform colored displaying.

In the display substrate 200 provided by the present disclosure, the multiple beams of light passing through the light-splitting film 220 and incident onto the base 240 are colored light beams which need not to be filtered by a color filter film any more. Hence, a brightness of a display panel including the display substrate 200 provided by the present disclosure may be increased. When the same energy is consumed, a brightness of a display device including the display substrate 200 provided by the present disclosure is about three times of that of the display device shown in FIG. 1. In other words, an image having a desired brightness may be displayed with lower energy consumption. Thus, the display substrate provided by the present disclosure may make a display device more energy-efficient when the display substrate is applied to the display device.

In the present disclosure, each light-splitting unit may include a plurality of light-splitting structures. FIG. 3 illustrates a principle diagram of a light-splitting unit in the display substrate of the present disclosure. As shown in FIG. 3, each light-splitting unit includes three light-splitting structures 2201, 2202 and 2203, wherein a light-splitting surface of each light-splitting structure has a stepped shape.

For easiness of control, optionally, a plurality of pixel units are arranged at the other side of the base 240 opposite to the first polarizer 210, and each light-splitting unit corresponds to one of the plurality of pixel units.

Optionally, each pixel unit includes three subpixel units. The light-splitting structures 2201-2203 in each light-splitting unit may split an incident light into a red light ray, a green light ray and a blue light ray which are incident into corresponding ones of the three subpixel units, respectively.

In the present disclosure, the display substrate 200 may be an array substrate or a cell-alignment substrate. It should be noted that, when the display substrate 200 is the array substrate, the array substrate is arranged between the backlight source and the cell-alignment substrate in a display device including the array substrate. In such case, no color-filter layer needs to be provided on the cell-alignment substrate. When the display substrate 200 is the cell-alignment substrate, the cell-alignment substrate is arranged between the backlight source and the array substrate in a display device including the cell-alignment substrate.

In the embodiment shown in FIG. 2, the display substrate 200 is formed as the array substrate. A pixel circuit 250 used for driving liquid-crystal molecules is formed at the other side of the base 240 opposite to the first polarizer 210. For example, the pixel circuit 250 may include gate lines, data lines, common electrode lines, pixel electrodes, a common electrode, etc.

The pixel circuit 250 is divided into a plurality of pixel units, as shown in FIG. 3. Each pixel unit includes a red subpixel unit 2501r, a green subpixel unit 2501g and a blue subpixel unit 2501b. The light emitted from the light-splitting unit corresponding to each pixel unit is split into red light irradiated towards the red subpixel unit 2501r (see a region defined by dashed lines in FIG. 3), green light irradiated towards the green subpixel unit 2501g (see a region defined by dot-dashed lines in FIG. 3) and blue light irradiated towards the blue subpixel unit 2501b (see a region defined by double-dot-dashed lines).

In the present disclosure, the light-splitting film 220 is formed on the first polarizer 210. Hence, after the first polarizer 210 is formed, the light-splitting film 220 may be formed at one side of the first polarizer 210, so that an integrated structure including the first polarizer 210 and the light-splitting film 220 may be obtained. The integrated structure including the first polarizer 210 and the light-splitting film 220 may be attached to one side of the base 240 opposite to the pixel circuit by using an adhesive 230. It should be noted that, when the integrated structure including the first polarizer 210 and the light-splitting film 220 is attached by using the adhesive 230, the adhesive 230 should not affect the light-splitting structures 2201-2203 on the light-splitting film 220. For example, the adhesive 230 may only be applied to edges of the base 240 and should not cover the light-splitting structures 2201-2203 on the light-splitting film 220.

As shown in FIG. 3, there is a gap between the light-splitting film 220 and the base 240. A color of each of the subpixel units 2501r, 2501g and 2501b may be accurately controlled by suitably arranging the gap between the light-splitting film 220 and the base 240. In the present disclosure, the gap between the light-splitting film 220 and the base 240 may be adjusted by adjusting a thickness of the adhesive 230.

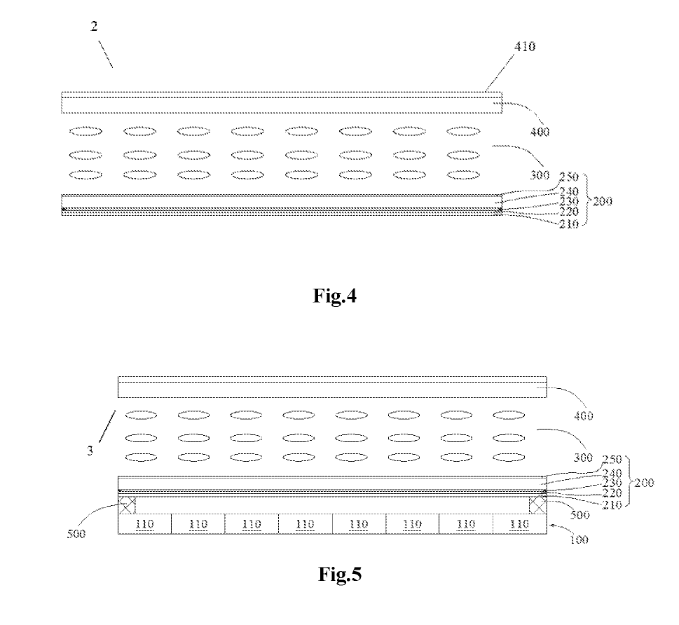

In another aspect of the present disclosure, a display panel 2 shown in FIG. 4 is provided. The display panel 2 includes a first display substrate 200 and a second display substrate 400. The first display substrate 200 and the second display substrate 400 are arranged oppositely so as to form a cell, wherein the first display substrate 200 is the above-mentioned display substrate provided by the present disclosure.

Because the first display substrate 200 is the above-mentioned display substrate provided by the present disclosure, the first display substrate 200 includes the light-splitting film 220 arranged at a light-emergent side of the first polarizer 210, wherein the light-splitting film 220 splits the white linearly polarized light into multiple beams of linearly polarized light having different wavelengths (i.e., having different colors). Thus, no color-filter film needs to be provided in the display panel 2. If the display panel 2 provided by the present disclosure is used in a display device, an image having a desired brightness may be displayed when the backlight source provides light having a lower brightness. In this way, the display panel 2 provided by the present disclosure is more energy-efficient.

It is readily understood that, the display panel 2 provided by the present disclosure may be a liquid crystal display panel. Therefore, the display panel 2 further includes a liquid crystal layer 300 encapsulated between the first display substrate 200 and the second display substrate 400.

It is further readily understood that, a light emergent surface of the second display substrate 400 has a second polarizer 410 provided thereon. A polarization direction of the second polarizer 410 on the second display substrate 400 is perpendicular to a polarization direction of the first polarizer 210 on the first display substrate 200.

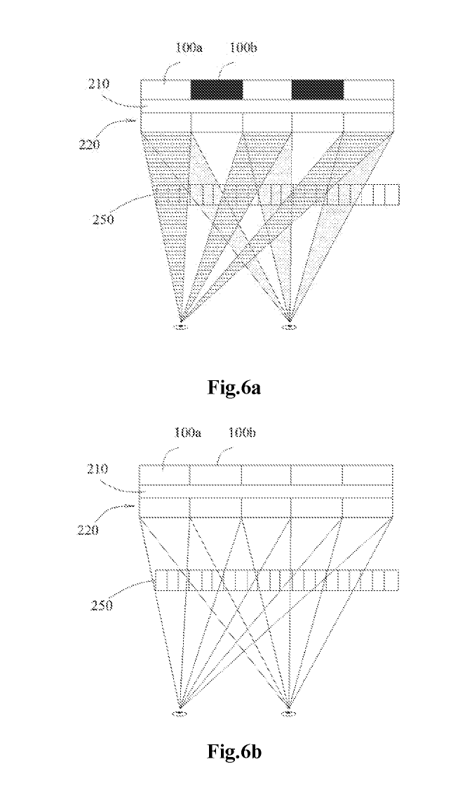

In another aspect of the present disclosure, a display device 3 shown in FIG. 5 is provided. The display device 3 includes a display panel and a backlight source 100. The display panel is the above display panel 2 provided by the present disclosure. The first polarizer 210 of the first display substrate 200 faces the backlight source 100.

Because the first display substrate 200 includes the light-splitting film 220 arranged at the light-emergent side of the first polarizer 210, the light-splitting film 220 may split the white linearly polarized light into multiple beams of linearly polarized light having different wavelengths (i.e., having different colors). Thus, no color-filter film needs to be provided in the display panel 2. An image having a desired brightness may be displayed when the backlight source 100 provides light having a lower brightness. Therefore, the display device 3 provided by the present disclosure is more energy-efficient.

In the present disclosure, a structure of the backlight source 100 is not specifically limited. For example, the backlight source 100 may include a light emitting element and optical films such as a light guide plate, a diffusion plate, etc.

In order to decrease a thickness of the backlight source 100, optionally, the backlight source 100 is divided into a plurality of light emitting regions, and each light emitting region has at least one light-emitting diode 110 provided therein.

Each light-emitting diode 110 may be controlled independently. Hence, a brightness of each light emitting region may be adjusted independently. In other words, a local dimming function of the display device 3 may be implemented by using the backlight source 100 including the light-emitting diodes 110, so that an image with a better contrast may be displayed.

In the present disclosure, a connection manner between the backlight source 100 and the display panel 2 is also not specifically limited. For example, the backlight source 100 can be fixedly attached to the display panel 2 by using a front frame.

As an optional embodiment of the present disclosure, the backlight source 100 and the display panel 2 are adhered together by a sealant 500 surrounding the display panel 2.

Optionally, the backlight 100, the display panel 2 and the sealant 500 together form a closed chamber. As mentioned above, the backlight source 100 may include a plurality of organic light-emitting diodes 110 that emit white light. External moisture may be prevented from entering a space between the backlight source 100 and the display panel 2 after the closed chamber is formed between the backlight source 100 and the display panel 2, thereby preventing the organic light-emitting diodes 110 from being oxidated and corroded by the moisture and prolonging lifetime of the display device.

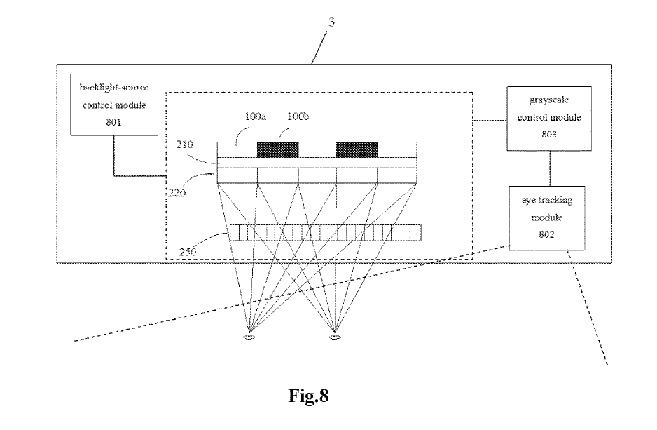

Optionally, as shown in FIG. 8, the display device 3 may further include a backlight-source control module 801. A light-emitting region of the backlight source 100 includes light-emitting subregions 100a and shielding subregions 100b which are arranged alternately. The backlight-source control module 801 may control light-emitting diodes of the shielding subregions 100b to not emit light (i.e., to be turned off) and control light-emitting diodes of the light-emitting subregions 100a to emit light.

Optionally, the display device 3 provided by the present disclosure may switch between a stereoscopic display mode and a planar display mode. As shown in FIG. 6a, when the display device 3 performs a stereoscopic display mode for naked-eyes, the backlight-source control module 801 controls the light-emitting diodes of the shielding subregions 100b to not emit light and controls the light-emitting diodes of the light-emitting subregions 100a to emit light. Therefore, the backlight source 100 may form a grating. A left-eye image and a right-eye image are displayed by the display panel 2. One part of the light emitted from the light-emitting subregions 100a is guided to pixels displaying the left-eye image by corresponding light-splitting structures on the light-splitting film 220, and the other part of the light emitted from the light-emitting subregions 100a is guided to pixels displaying the right-eye image by the corresponding light-splitting structures on the light-splitting film 220. Finally, a left-eye viewpoint and a right-eye viewpoint are formed at the light-emergent side of the display panel. When the eyes of an observer are located at the left-eye viewpoint and the right-eye viewpoint, respectively, the left eye of the observer may see the left-eye image and the right-eye of the observer may see the right-eye image, and the left-eye image and the right-eye image are superimposed in the brain of the observer, and thus a stereoscopic image is seen.

When the display device 3 performs the planar display mode, referring to FIG. 6b, the light-emitting diodes of the shielding subregions 100b and the light-emitting subregions 100a are controlled to emit light.

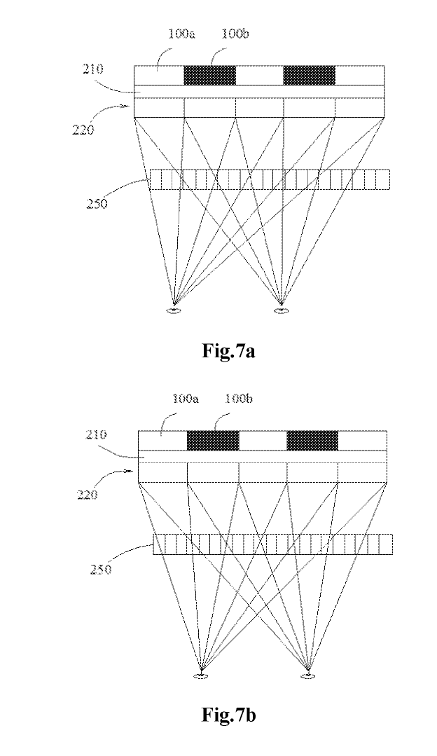

Optionally, referring to FIGS. 7a-7b and FIG. 8, the display device 3 further includes an eye tracking module 802 and a grayscale control module 803. The eye tracking module 802 may obtain location information of the eyes of the observer and may send the obtained location information of the eyes to the grayscale control module 803, and the grayscale control module 803 may generate an image directly facing the eyes of the observer according to the location information of the eyes received by the grayscale control module 803. Wherever the observer is located, the observer is made to be at a optimum viewing location, so that no image crosstalk occurs.

When the observer is located at a location shown in FIG. 7a, the eye tracking module 802 may obtain the location information of the eyes and send the obtained location information of the eyes to the grayscale control module 803, and the grayscale control module 803 may generate an image that directly faces the observer. When the observer is located at a location shown in FIG. 7b, the eye tracking module 802 may obtain the location information of the eyes and send the obtained location information of the eyes to the grayscale control module 803, and the grayscale control module 803 may also generate an image that directly faces the observer.

It should be understood that the above embodiments are merely illustrative embodiments used to illustrate principles of the present disclosure and the scope of the present disclosure is not limited thereto. A person of ordinary skills in the art may make various improvements and modifications without departing from the principle and scope of the present disclosure, and these improvements and modifications shall also fall within the scope of the present disclosure.

1. A display substrate, comprising:
a base;
a first polarizer arranged at one side of the base; and
a light-splitting film arranged between the first polarizer and the base, wherein a plurality of light-splitting structures are formed on a surface of the light-splitting film facing one side of the base, the surface of the light-splitting film facing one side of the base is divided into a plurality of light-splitting units, and the light-splitting structures in each of the plurality of light-splitting units are configured to split light incident onto the light-splitting unit into multiple beams of light having different wavelengths and different emergent directions.

2. The display substrate according to claim 1, wherein a plurality of pixel units are arranged at the other side of the base and each of the plurality of light-splitting units corresponds to one of the pixel units.

3. The display substrate according to claim 2, wherein each of the pixel units comprises three subpixel units, and the light-splitting structures in each of the plurality of light-splitting units are configured to split incident light into a red light ray, a green light ray and a blue light ray, and the red light ray, the green light ray and the blue light ray enter corresponding subpixel units of the three subpixel units, respectively.

4. The display substrate according to claim 1, wherein a pixel circuit is formed at the other side of the base.

5. The display substrate according to claim 1, wherein the display substrate further comprises an adhesive for attaching the light-splitting film with the base, and the adhesive is arranged to surround edges of the base.

6. The display substrate according to claim 1, wherein each of the plurality of light-splitting units comprises three light-splitting structures, and a light-splitting surface of each of the plurality of light-splitting units has a stepped shape.

7. A display panel, comprising:
a first display substrate; and
a second display substrate arranged opposite to the first display substrate and forming a cell with the first display substrate, wherein the first display substrate is the display substrate according to claim 1.

8. The display panel according to claim 7, wherein a second polarizer is formed at a side of the second display substrate facing away from the first display substrate, and a polarization direction of the second polarizer is perpendicular to a polarization direction of the first polarizer.

9. A display device, comprising:
the display panel according to claim 7; and
a backlight source, wherein the polarizer of the first display substrate faces the backlight source.

10. The display device according to claim 9, wherein the backlight source is divided into a plurality of light-emitting regions, and each of the plurality of light-emitting regions has at least one light-emitting diode provided therein.

11. The display device according to claim 10, wherein the backlight source and the display panel are adhered together by a sealant surrounding the display panel.

12. The display device according to claim 11, wherein the backlight source, the display panel and the sealant form a closed chamber together.

13. The display device according to claim 10, further comprising a backlight-source control module, wherein the plurality of light-emitting regions of the backlight source comprise light-emitting subregions and shielding subregions, the light-emitting subregions and the shielding regions are arranged alternately, and the backlight-source control module is configured to control light-emitting diodes of the shielding subregions to not emit light and control light-emitting diodes of light-emitting subregions to emit light.

14. The display device according to claim 13, further comprising an eye tracking module and a grayscale control module, wherein the eye tracking module is configured to obtain location information of eyes of an observer and send the obtained location information of the eyes to the grayscale control module, and the grayscale control module is configured to generate an image directly facing the eyes of the observer according to the location information of the eyes received by the grayscale control module.

15. The display substrate according to claim 2, wherein each of the plurality of light-splitting units comprises three light-splitting structures, and a light-splitting surface of each of the plurality of light-splitting units has a stepped shape.

16. The display substrate according to claim 3, wherein each of the plurality of light-splitting units comprises three light-splitting structures, and a light-splitting surface of each of the plurality of light-splitting units has a stepped shape.

17. The display substrate according to claim 2, wherein a pixel circuit is formed at the other side of the base.

18. The display substrate according to claim 2, wherein the display substrate further comprises an adhesive for attaching the light-splitting film with the base, and the adhesive is arranged to surround edges of the base.

19. A display panel, comprising:
a first display substrate; and
a second display substrate arranged opposite to the first display substrate and forming a cell with the first display substrate, wherein the first display substrate is the display substrate according to claim 2.

20. The display device according to claim 11, further comprising a backlight-source control module, wherein the plurality of light-emitting regions of the backlight source comprise light-emitting subregions and shielding subregions, the light-emitting subregions and the shielding regions are arranged alternately, and the backlight-source control module is configured to control light-emitting diodes of the shielding subregions to not emit light and control light-emitting diodes of light-emitting subregions to emit light.
